(19) United States
(12) Patent Application Publication
(10) Pub. No.: US 2024/0338753 A1
(43) Pub. Date: Oct. 10, 2024

(54) SYSTEM FOR AUTOMATICALLY GENERATING MERCHANDISE LISTINGS FROM SINGLE USER TEXT INPUT

(71) Applicant: Brianna Nicole Gibson, Palm Bay, FL (US)

(72) Inventor: Brianna Nicole Gibson, Palm Bay, FL (US)

(21) Appl. No.: 18/130,545

(22) Filed: Apr. 4, 2023

(51) Int. Cl. G06Q 30/0601; G06Q 30/08

(52) U.S. Cl. CPC G06Q 30/0643; G06Q 30/08

(57) ABSTRACT

A system for automatically generating merchandise listings from single user text input is disclosed. The system may include an application system configured to generate at least one image and a corresponding product listing based on text-only input. The system may be configured to allow creator/seller users to bid on product listings and allow buyer-users to purchase the services of creator/seller users. Creator/seller users may utilize the generated at least one image and a corresponding product listing to create products.

### TECHNICAL FIELD

The embodiments generally relate to computerized systems for systematically generating merchandise or sales listings on a webpage.

### BACKGROUND

Online marketplaces, such as web-based auctions sites or product sales sites, rely on user input to provide a webpage dedicated to a specific seller posting for existing products. Online marketplaces rely on purchaser-users browsing the online marketplace in a list format or other, often cumbersome, product listing format.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments generally relate to a software-as-a-service (SaaS) platform that automatically creates a product listing from user text input. The platform uses a workflow automation tool to create an artificial intelligence (AI) image from user text input and matches said image to physical product image. The buyer-user can use the physical product image to automatically create a listing for creators/seller users to bid on. A list of bids is then sent to the buyer to review, accept, or reject. The system enables a unique online peer-to-peer marketplace where buyers create a listing of a product they wish to buy, and sellers bid on the opportunity to create or make said item for buyer.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a block diagram of a computing system and an application program, according to some embodiments; and

FIG. 3 illustrates a block diagram of a computing system and an application program, according to some embodiments.

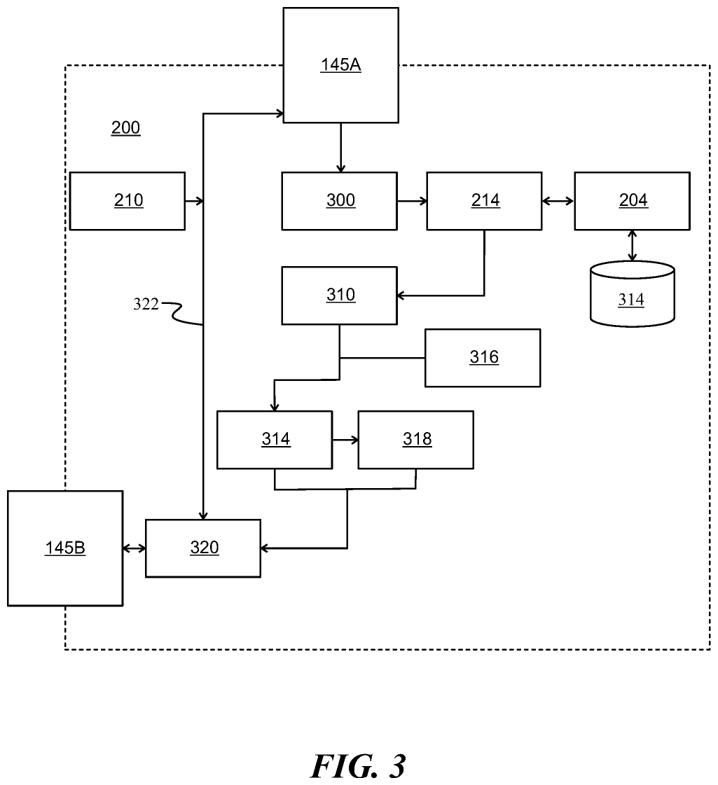

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

As used herein, the term “user” may be utilized to relate to any user of the system including buyer-users i.e. individuals accessing the system to generate images and product listings; and creator/seller users i.e. users who may bid on product listings or create or sell products relating to the system generated images. “User” may also refer to non-buyer-users, and non-creator/seller users, including users browsing product listings, administrator users, and the like.

The embodiments generally relate to a software-as-a-service (SaaS) platform that automatically creates a product listing from user text input. The platform uses a workflow automation tool to create an artificial intelligence (AI) image from user text input and matches said image to physical product image. The buyer-user can use the physical product image to automatically create a listing for creators/seller users to bid on. A list of bids is then sent to the buyer to review, accept, or reject. The system enables a unique online peer-to-peer marketplace where buyers create a listing of a product they wish to buy, and sellers bid on the opportunity to create or make said item for buyer.

The embodiments generally relate to a system utilizing workflow automation tools to create artificial intelligence generated images to build an online product environment. The system may receive buyer-user input in the form of text input and the system may utilize a text to image artificial intelligence API to generate images for a product as well as a product listing web page on the system platform. The generated images may relate to a product the buyer-user is seeking to have custom made. The system may generate any number of AI generated images relating to the desired product, such as, but not limited to, three images for the buyer user to review.

The system may simultaneously moderate generated and selected images to be communicated to a creator/seller portal, accessible by creator/seller users. Generated and selected images may be moderated using automated workflow with an API, as well as manual administrative approval and denial methods, such as via an internal administrator portal or hard manual database review. The moderation API will screen the user text-input before displaying the images using pass/fail set points i.e indications of violence, self-harm, bullying, or other offensive or illicit material. When a product listing is created by a user, the listing can be administratively reviewed many times more for approval or denial. The creator/seller portal may be configured to allow creator/seller users to review generated product listing web pages and place bids to win a project to create and deliver a product similar to the generated image(s).

In this way, the system provides a peer-to-peer marketplace for the creation, sale, and purchase of unique items and products based on AI-generated images.

As a non-limiting example, a buyer-user may utilize the system to input a text-only prompt to the system, such as, “blue gem, gold braid, bracelet.” The system may utilize a text to image artificial intelligence API to generate images relating to the text-only input. According to this example, the system may generate two, three, or four AI-generated images of bracelets featuring gold braiding and in-laid sapphire gems. The AI-generated images may be communicated to a buyer-user device such that the buyer-user may review the images and select the most desirous product image. Alternatively, the buyer-user may have the system generate a different set of images from the same text prompt or different text prompt.

The buyer-user may then select the desired image and the system may automatically generate a product listing webpage displaying the image and communicate the product listing to creator/seller users via the creator/seller portal.

Creator/seller users may browse and select generated product listings and bid on listings in order to “win” projects. Bids may include product creation, estimated lead times, materials, sizing options, and costs related to creation of a product based on the selected image. Buyer-users may receive and review bids on their specific product listing and reject or choose winning bids. Bid- winning creator/sellers may then proceed with creation of a product based on the selected image associated with the product listing.

According to some embodiments, the system may be configured to convert two- dimensional AI generate images in three-dimensional design files, such as design files commonly associated with three-dimensional product rendering software. Alternatively, the system may be configured to generate three-dimensional design files based on user text input. Creator/sellers may be communicated said design files to facilitate prompt creation of the product.

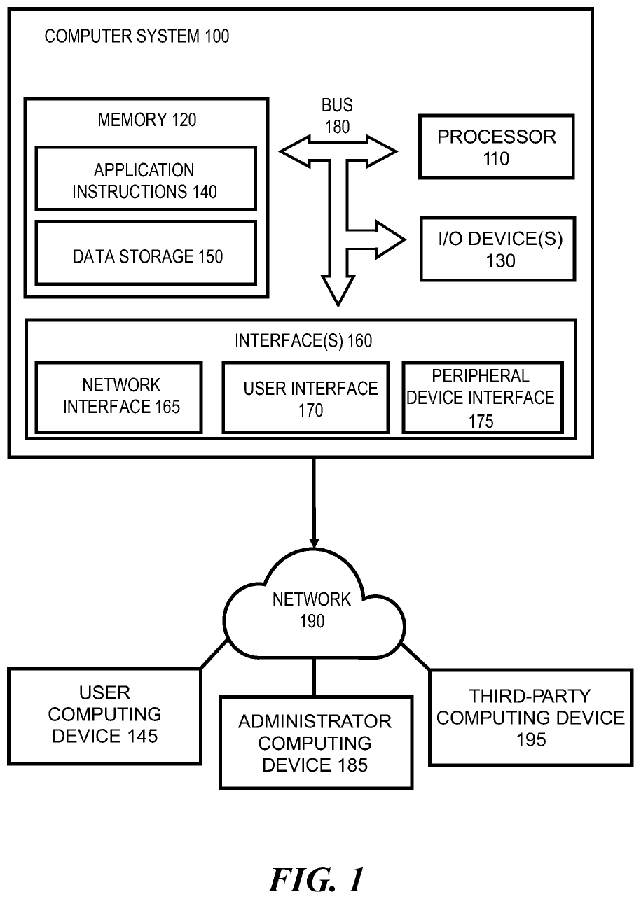

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum- dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state- setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field- programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer- readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer- readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer- readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on- demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized to establish credentials, create a user profile, and otherwise interact with the various property management and real estate investment functionalities of the system. The third-party computing device 195 may be utilized by third parties to receive communications from the user computing device and/or administrative computing device 185. In one example, a third-party may be a franchisee.

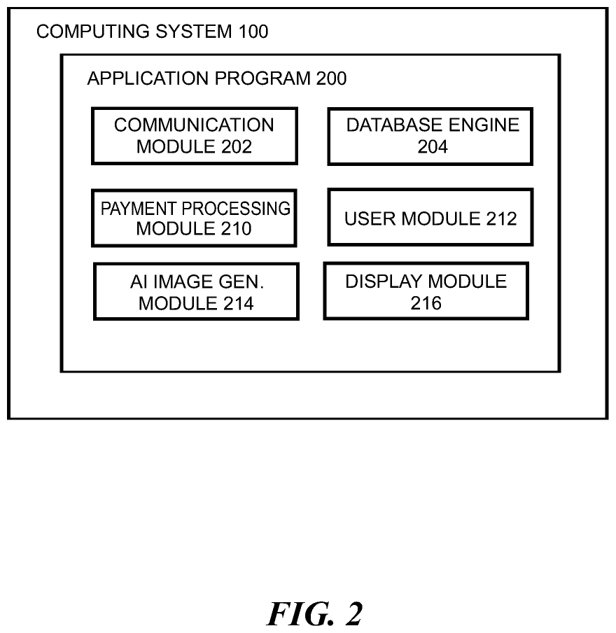

FIGS. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a payment processing module 210, a user module 212, an AI image generating module 214, and a display module 216.

In some embodiments, the communication module 202 is configured for receiving, processing, and transmitting a user command and/or user text-only input. In such embodiments, the communication module 202 performs communication functions between various devices, including a user computing device 145, a administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 allows each user to transmit and receive information which may be used by the system.

The communication module 202 is operable to transmit alerts as described hereinabove.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. The database engine 204 allows each user and module associated with the system to transmit and receive information stored in various databases.

In some embodiments, the payment processing module 210 is configured to permit users to set up payments to a creator/seller user. When the payment method listed on their user profile is charged, the user will receive a notification informing them of the transaction. Payments may be processed using various processes known in the arts. The payment processing module 210 may be configured to receive and manage bids from creator/seller users and allow buyer-users to select bids such that a transaction may be initiated for the creation of a product based on the AI generated image(s).

In some embodiments, the user module 212 facilitates the creation of a user account for the application system. The user module 212 may allow the user to input account information, user preferences, and the like.

In some embodiments, the AI image generation module 214 is configured to generate images via an artificial intelligence-based API. AI image generation may include a model and training the model on a dataset of images to learn patterns and features that define the images. Once the AI image generation module 214 is trained, it may generate new images that are similar to the original images, but not identical. AI images may be generated through, for example, generative modeling, which involves using machine learning algorithms to learn patterns and features from existing images and then use those learned patterns to generate new images.

AI images may be generated by encoding images into a lower-dimensional space called the “latent space.” This encoded representation is then used to generate new images that are similar but not identical to the original images. AI image generation models may be trained using a combination of supervised and unsupervised learning, where the model is trained to minimize the difference between the input image and the generated image. AI images may be generated via a system consisting of a generator and a discriminator. The generator may be trained to generate images that are indistinguishable from real images, while the discriminator may be trained to differentiate between real and fake images. The generator and discriminator may be trained together, with the generator attempting to “trick” the discriminator by generating increasingly realistic images, while the discriminator becomes more accurate at identifying fake images. AI images may also be generated one pixel at a time, with each pixel being dependent on the previous pixels. AI images may be generated using a probabilistic approach to generate new images, where the probability of each pixel being a certain color is calculated based on the previous pixels in an image.

In some embodiments, the AI image generation module 214 is configured to receive text- only input via a user device, such as via a fillable field within the system GUI, and the system may generate a single image or a plurality of images based on the text-only input via any of the aforementioned methods.

In some embodiments, the display module 214 is configured to display one or more GUIs, including, e.g., one or more user interfaces or one or more consumer interfaces. In some embodiments, the display module 214 is configured to temporarily generate and display various pieces of information in response to one or more commands or operations, such as the systematically generated product listings and generated images. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed via the display module 214 may not be persistently stored.

In some embodiments, the display module 214 is configured to display the AI-generated images created by the system, on the one or more GUIs.

The embodiments generally relate to an application program 200 that automatically generates a product listing 312 from user text input 300 via a user device 145A. The system may receive buyer-user input in the form of text input 300 and the system may utilize a text to image artificial intelligence API, module, or model 214 to generate images 310. The model 214 may be trained on images within the database engine 204 in operable communication with database storage 314. Upon receiving user text input 300, the model 214 may generate at least one AI-generated image 310 based on user text input 300. The system may generate any number of AI generated images relating to the desired product, such as, but not limited to, three images for the buyer user to review. The system may also moderate 314 generated and selected images to be communicated to a creator/seller portal.

Subsequently, the application program 200 may generate a product listing 314 including the at least one AI-generated image 310. According to some embodiments, the system may also generate a product listing web page 318 accessible via the application program 200. The generated images may relate to a product the buyer-user is seeking to have custom made.

The product listing 314 or product listing web page 318 may be accessible, browsable, and viewable to a creator/seller user device 145B via the GUI. The system may receive creator/seller bids 320, such as via the payment processing module and via creator/seller user device 145B associated with specific product listings 314 or product listing web pages 318 and communicate bids to the user device 145A. User device 145A may also facilitate communication 322 of product details, such as sizing, materials, colors, and the like, to the creator/seller user device 145B to facilitate creation and sale of a target product. Communication 322 may include a messaging feature or call feature configured to allow users of the user device 145A and the creator/seller user device 145B to communicate with one another prior to or after a bid has been submitted or accepted.

The system may also facilitate payment to the creator/seller user device 145B from the user device 145A via payment processing module 210.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer- executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single- processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

The following description of variants is only illustrative of components, elements, acts, product, and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

According to variation 1, a system for automatically generating merchandise listings from single user text input, the system including at least one device in operable connection with a network; and an application server in operable communication with the network, the application server configured to host an application system displaying at least one system generated image and a corresponding product listing, the application system having a display module for providing access to the application system via a GUI displayed on at least one user device, the GUI to permit the user to interact with a communication module to receive information related to the at least one system generated image and the corresponding product listing.

Variation 2 may include a system as in variation 1, including an AI image generating module configured to generate the at least one system generated image based on user text-only input.

Variation 3 may include a system as in variation 1 or 2, including a database engine configured to facilitate generation of the at least one system generated image in cooperation with the AI image generating module.

Variation 4 may include a system as in any of variations 1 through 3, wherein the application system is configured to generate at least one of a product listing including the at least one system generated image.

Variation 5 may include a system as in any of variations 1 through 4, including a display module configured to display the at least one product listing on a user device.

Variation 6 may include a system as in any of variations 1 through 5, wherein the application system is configured to generate at least one product web page including the at least one system generated image.

Variation 7 may include a system as in any of variations 1 through 6, including a display module configured to display the at least one product listing web page on a user device.

Variation 8 may include a system as in any of variations 1 through 7, wherein the application system is configured to receive at least one bid and communicate the at least one bid to the at least one user device.

Variation 9 may include a system as in any of variations 1 through 8, wherein the application system is configured to receive user input accepting the at least one bid via the at least one user device.

Variation 10 may include a system as in any of variations 1 through 9, including a payment processing module configured to facilitate payment from the at least one user device to a second at least one user device.

According to variation 11, a computer program product may include a user interface configured to provide access to the computer program product via at least one computing device, the user interface being configured to permit a user to interact with a communication module to receive information related to a property, wherein the communication module transmits alerts to and from a first computing device; a communication module configured to allow one or more users to communicate with one another via the first computing device and a second computing device; a database engine configured to facilitate storage, management, and retrieval of data to and from one or more storage mediums; an AI image generating module configured to generate at least one image based on text-only input via an artificial intelligence-based API; an application program configured to generate at least one product listing from the at least one image; and a payment processing module configured to receive and manage bids such that a transaction may be initiated for creation of a product based on the at least one image.

Variation 12 may include a computer program product as in variation 11, wherein the AI image generating module is configured to generate the at least one image based on generative modeling.

Variation 13 may include a computer program product as in variation 11 or 12, wherein the AI image generating module is configured to generate the at least one image via a probabilistic approach.

Variation 14 may include a computer program product as in any of variations 11 through 13, wherein the AI image generating module includes a generator and a discriminator, wherein generator is trained to generate images that are indistinguishable from real images, and wherein the discriminator is trained to differentiate between real and fake images.

Variation 15 may include a computer program product as in any of variations 11 through 14, further including a display module configured to provide access to the computer program product via a GUI displayed on at least one user device.

Variation 16 may include a computer program product as in any of variations 11 through 15, wherein the display module is configured to display the at least one product listing on a user device.

Variation 17 may include a computer program product as in any of variations 11 through 16, including a display module configured to display the at least one product listing on a user device.

Variation 18 may include a computer program product as in any of variations 11 through 17, wherein the application program is configured to generate at least one product web page including the at least one image.

Variation 19 may include a computer program product as in any of variations 11 through 18, further including a display module configured to display the at least one product listing web page on a user device.

According to variation 20, a computer program product may include a user interface configured to provide access to the computer program product via at least one computing device, the user interface being configured to permit a user to interact with a communication module to receive information related to a property, wherein the communication module transmits alerts to and from a first computing device; a communication module configured to allow one or more users to communicate with one another via the first computing device and a second computing device; a database engine configured to facilitate storage, management, and retrieval of data to and from one or more storage mediums; an AI image generating module configured to generate, via at least one of generative modeling or probabilistic approach, at least one image based on text-only input; an application program configured to generate at least one product listing from the at least one image and depicting the at least one image; a payment processing module configured to receive and manage bids such that a transaction may be initiated for creation of a product based on the at least one image; and a display module configured to display the at least one product listing on a user device.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for automatically generating merchandise listings from single user text input, the system comprising:
at least one device in operable connection with a network; and
an application server in operable communication with the network, the application server configured to host an application system displaying at least one system generated image and a corresponding product listing, the application system having a display module for providing access to the application system via a GUI displayed on at least one user device, the GUI to permit the user to interact with a communication module to receive information related to the at least one system generated image and the corresponding product listing.

2. The system of claim 1, comprising an AI image generating module configured to generate the at least one system generated image based on user text-only input.

3. The system of claim 2, comprising a database engine configured to facilitate generation of the at least one system generated image in cooperation with the AI image generating module.

4. The system of claim 3, wherein the application system is configured to generate at least one of a product listing comprising the at least one system generated image.

5. The system of claim 4, comprising a display module configured to display the at least one product listing on a user device.

6. The system of claim 3, wherein the application system is configured to generate at least one product web page comprising the at least one system generated image.

7. The system of claim 6, comprising a display module configured to display the at least one product listing web page on a user device.

8. The system of claim 1, wherein the application system is configured to receive at least one bid and communicate the at least one bid to the at least one user device.

9. The system of claim 8, wherein the application system is configured to receive user input accepting the at least one bid via the at least one user device.

10. The system of claim 1, comprising a payment processing module configured to facilitate payment from the at least one user device to a second at least one user device.

11. A computer program product, comprising:
a user interface configured to provide access to the computer program product via at least one computing device, the user interface being configured to permit a user to interact with a communication module to receive information related to a property, wherein the communication module transmits alerts to and from a first computing device;
a communication module configured to allow one or more users to communicate with one another via the first computing device and a second computing device;
a database engine configured to facilitate storage, management, and retrieval of data to and from one or more storage mediums;
an AI image generating module configured to generate at least one image based on text- only input via an artificial intelligence-based API;
an application program configured to generate at least one product listing from the at least one image; and
a payment processing module configured to receive and manage bids such that a transaction may be initiated for creation of a product based on the at least one image.

12. A computer program product as in claim 11, wherein the AI image generating module is configured to generate the at least one image based on generative modeling.

13. A computer program product as in claim 11, wherein the AI image generating module is configured to generate the at least one image via a probabilistic approach.

14. A computer program product as in claim 11, wherein the AI image generating module comprises a generator and a discriminator, wherein generator is trained to generate images that are indistinguishable from real images, and wherein the discriminator is trained to differentiate between real and fake images.

15. A computer program product as in claim 11, further comprising a display module configured to provide access to the computer program product via a GUI displayed on at least one user device.

16. A computer program product as in claim 15, wherein the display module is configured to display the at least one product listing on a user device.

17. A computer program product as in claim 16, comprising a display module configured to display the at least one product listing on a user device.

18. A computer program product as in claim 11, wherein the application program is configured to generate at least one product web page comprising the at least one image.

19. A computer program product as in claim 11, further comprising a display module configured to display the at least one product listing web page on a user device.

20. A computer program product, comprising:
a user interface configured to provide access to the computer program product via at least one computing device, the user interface being configured to permit a user to interact with a communication module to receive information related to a property, wherein the communication module transmits alerts to and from a first computing device;
a communication module configured to allow one or more users to communicate with one another via the first computing device and a second computing device;
a database engine configured to facilitate storage, management, and retrieval of data to and from one or more storage mediums;
an AI image generating module configured to generate, via at least one of generative modeling or probabilistic approach, at least one image based on text-only input;
an application program configured to generate at least one product listing from the at least one image and depicting the at least one image;
a payment processing module configured to receive and manage bids such that a transaction may be initiated for creation of a product based on the at least one image; and
a display module configured to display the at least one product listing on a user device.
